(19) United States
(12) Patent Application Publication
(10) Pub. No.: US 2023/0373248 A1
(43) Pub. Date: Nov. 23, 2023

(54) Higher traction, low-profile tires, for exotic/oversized wheels, DOT approved, and non-DOT approved for rear tires

(71) Applicant: Matthew Haley, Zachary, LA (US)

(72) Inventor: Matthew Haley, Zachary, LA (US)

(21) Appl. No.: 17/663,745

(22) Filed: May 17, 2022

(51) Int. Cl. B60C 3/04

(52) U.S. Cl. CPC B60C 3/04

(57) ABSTRACT

Big wheel cars that have wheels with diameters of 24″, 26″, and 28″ have tires that are currently made specifically for various weather conditions which require the tires to have tread on the face of the tire, but nothing regarding high performance or racing applications. This invention will give the rear of the car more traction and safer stopping/steering performances during high performance applications that include DOT approved tires for public highways, and non-DOT approved tires for racing applications on raceways.

### BACKGROUND OF THE INVENTION

### 1. Field of the Invention

To allow vehicles with rear wheels with overall diameters of 24″, 26″, and 28″ to have a high-performance low-profile tire with an all-smooth surface area for maximum traction along with meeting minimum DOT approved tread pattern for daily use on public streets, or raceways.

### 2. Discussion of the Prior Practices

Cars with exotic oversized wheels with diameters ranging from 24″, 26″ and 28″ usually have extremely low-profile tires on the rear wheels with tread patterns that is used for daily driving conditions where they are used in various types of weather conditions such as rain, mud, slippery roads, and snow. But within the last 3 years cars with oversized wheels have been known to drag race their cars with big wheels while never considering high traction and high-performance applications. The only rear low-profile tires on the market that are large enough for these size wheels are not manufactured for high performance applications such as rapid acceleration, speed, traction, steering, and stopping. With this tire invention people would finally have a low-profile tire for oversized wheels that were capable of being used on public highways while also getting maximum traction for rapid acceleration during racing applications at local raceways while ensuring that the safety of the driver will be met by having maximum steering, stopping, and traction for better handling for the rear of the vehicle.

One object of the present invention is to allow the public to have the first low-profile tire for oversized wheels that can be used on the rear of the vehicle at the race way during racing applications, and to also have tires of the same size that are legal on the public highways.

### SUMMARY OF THE INVENTION

A rear tire that has an all-smooth surface area on the face of the tire to allow more surface area contact with the ground for maximum traction that also has minimal tread on it to meet minimum DOT approved requirements for public highway use, and with an increased overall diameter larger than prior high-performance rear tires that are mounted on rear wheels significantly larger than prior high-performance rear wheels. While also being able to fit a rear wheel with a diameter of 24″, 26″ or 28″, while also having a sidewall profile (thickness) of 25, 30, or 35. This rear tire invention will also have a width ranging in various size options of 255, 245, 255, 265, 275, 285, 295, 305, 315, and 325.

### BRIEF DESCRIPTION OF THE FIGURES OF THE DRAWING

FIG. 1 is a side elevation view of the rear tire and how it will look with a tire profile size (thickness) of 25 while also being able to fit a rear wheel with a diameter of 24″, 26″ and 28″. While also having a sidewall profile (thickness) optional sizes available of 30, and 35.

FIG. 2 is a side elevation view of the rear tire and how it will look with a tire profile size (thickness) of 35 while also being able to fit a rear wheel with a diameter of 24″, 26″ and 28″. While also having a sidewall profile (thickness) optional size available of a 25, or 30.

FIG. 3. is a vertical cross-sectional view of the narrowest width rear tire size of 255 with an all-smooth surface area that meets DOT approved minimum requirements to be used on public highways and streets.

FIG. 4. Is a vertical cross-sectional view of the widest rear tire size of 325 with a possible minimum tread design that meets DOT-approved for use on public highways and streets.

FIG. 5. is a guide explaining how a rear tire is classified for high applications. Any tire with at least a Z rating is classified as a high-performance tire.

FIG. 6. is a guide explaining how to read rear tire sizes and how to read and interpret the overall sizes of a rear tire, what wheel diameter size it fits, tire sidewall profile (thickness), and width of the rear tire along with how the tire speed rating is classified.

### DESCRIPTION OF A PREFERRED EMBODIMENT

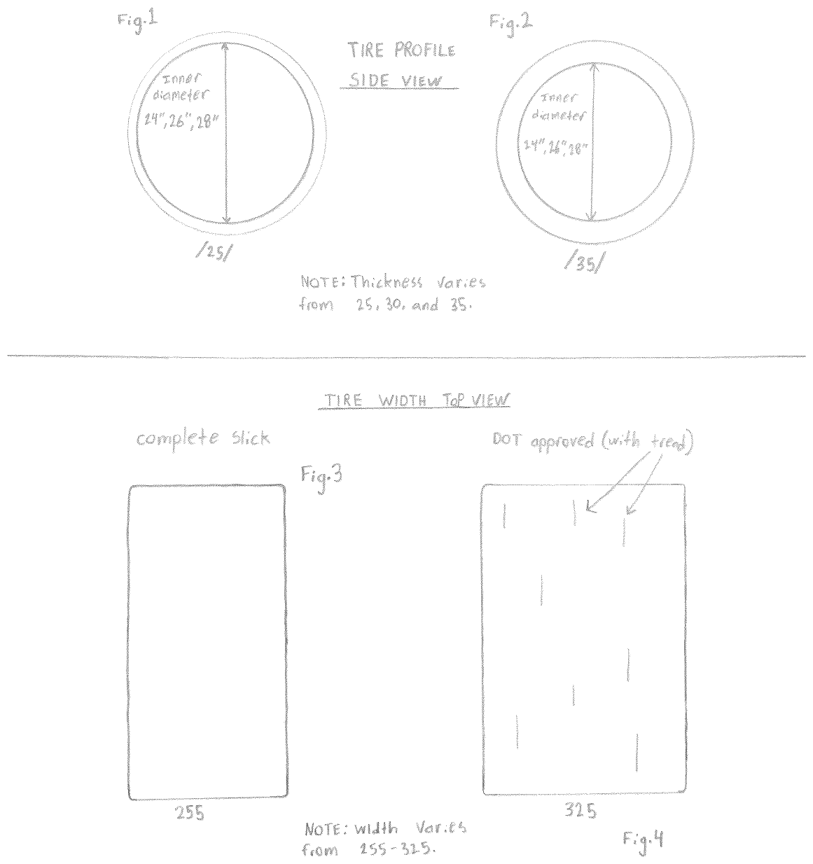

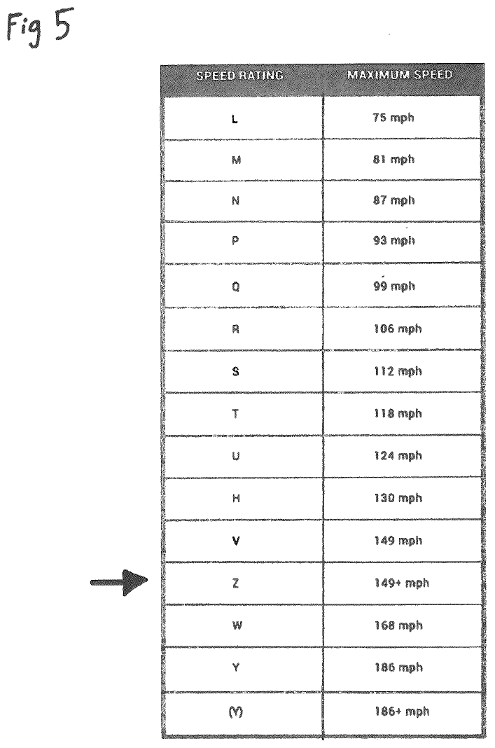

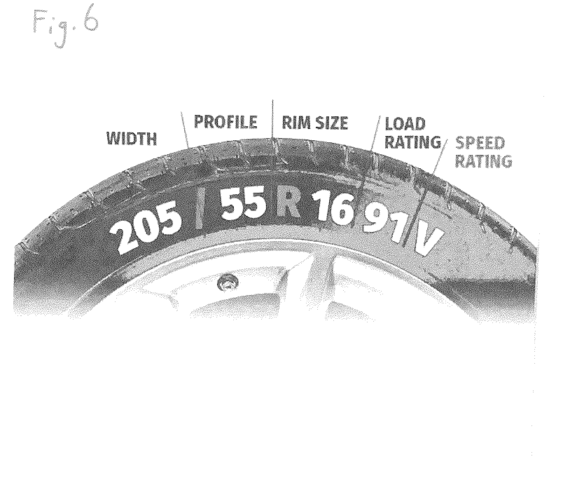

In FIG. 1, FIG. 2, FIG. 3 and FIG. 4 are different in certain ways but all of them serve the same purpose and that is to simply provide higher traction for the rear tires of cars with large diameter wheels on public highways and streets and to allow them maximum traction during rapid acceleration, steering, stopping, and excessive speed applications on public highways while having an all slick surface area on the footprint of the tire to allow more surface area contact with the ground creating maximum traction while also being able to use them at the raceway. Cars that have large rear wheels with overall diameters of 24″, 26″ and 28″ usually have a FIG. 6 low-profile sidewall tire ranging from /25/, /30/, or /35/ in size (thickness), with a FIG. 6 width of 255, 265, 275, 285, 295, 305, 315, or 325, are not FIG. 5 manufactured for high performance applications for even S rated speed rating let alone manufactured for high traction by having an all smooth race tire. This tire invention will provide rear tires for vehicles with maximum traction from accelerating quickly, steering, and stopping while also being able to take the abuse of centrifugal force during high speeds of FIG. 5 a Z rated tire. And these key points stated above will allow this rear tire invention to be the first high performance low-profile rear tire for oversized wheels that will be legal to use on public highways, streets, and raceways. And this rear tire invention will come in sizes FIG. 1 large enough in diameter for a 24″, 26″ and 28″ wheel, with a sidewall profile of /25/, /30/ and /35/ and width FIG. 4 from 255, 265, 275, 285, 295, 305, 315, and 325 while also implying that whatever combination of tire sizes previously stated, will be Z rated.

1. A high-performance low-profile tire for big wheels with diameters of 24″, 26″ or 28″ in diameter specifically for the rear of the car that is used in racing while also having the minimum amount of tread required to be approved by the Department of Transportation for daily use on public streets and highways, while also being non-DOT approved for raceway applications. While

2. The tire of claim 1 will be an all-slick tire (no tread) to allow maximum traction by having more surface contact area on the ground to allow better traction for rapid acceleration, steering, and stopping.

3. This tire will be specifically for wheels with overall diameters ranging in 24″, 26″ and 28″.

4. The tire width FIG. 4 will have the optional sizes of 255, 265, 275, 285, 295, 305, 315, and 325.

5. The tire (thickness) profile FIG. 4 will range in the optional sizes of /25/, /30/, and /35/.

6. This tire invention will cover all the sizes previously stated in claim 3, claim 4 and claim 5 but will also be made with 2 available options:
A) Racetrack use only (non-DOT approved).
B) Legal to use on public highways and streets (DOT approved).
